(19) United States
(12) Patent Application Publication
(10) Pub. No.: US 2009/0003849 A1
(43) Pub. Date: Jan. 1, 2009

(54) MOTOR CONTROL FOR PAPER JAM AT FUSER UNIT

(75) Inventors: Toshiya Inomata, Chigasaki-shi (JP); Satoshi Himeno, Mishima-shi (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/147,381

(22) Filed: Jun. 26, 2008

Related U.S. Application Data
(60) Provisional application No. 60/946,605, filed on Jun. 27, 2007.

(51) Int. Cl. G03G 15/00

(52) U.S. Cl. 399/21

(57) ABSTRACT

A developer image is formed by selectively supplying a developer based on a potential distribution corresponding to image information, the formed developer image is electrostatically attracted and transferred to a sheet material, the developer image is fixed to the sheet material by applying heat and pressure to the developer image transferred to the sheet material and the sheet material, and a drive force in a forward direction applied to the sheet material is cut off in a case where the sheet material is not ejected in a specified time, and then a drive force in a direction opposite to that of the drive force in the forward direction is applied for a specified time, and therefore, it is possible to prevent a sheet jammed in a fuser unit from being concealed in the fuser unit.

### CROSS-REFERENCE TO RELATED APPLICATIONS

This application claims the benefit of U.S. Provisional Application No. 60/946,605, filed Jun. 27, 2007.

### BACKGROUND OF THE INVENTION

1. Field of the Invention

The present invention relates to control of a fuser unit motor in a case where JAM (miss feed or sheet jam of a sheet material) occurs in a fuser unit of an image forming apparatus.

2. Description of the Related Art

In an electrophotographic system color image forming apparatus, a heat-fusible toner is used as a visualizing agent in many cases. The toner is selectively supplied to an electrostatic latent image as image information formed on a photoconductor, and is transferred as a toner image to a sheet material.

The toner which becomes the toner image is fused by the application of specified heat from a fuser unit, and is fixed to the sheet material.

For example, Jpn. Pat. Appln. KOKAI Publication No. 2005-227509 discloses that when JAM (miss feed or sheet jam of sheet material) occurs in a fuser unit, a brake is applied to a motor for rotating a roller body of the fuser unit so as to prevent the sheet material from being transported into the inside of the fuser unit by the inertia of the motor.

However, in the case where the size of the sheet material is small, there is case where the sheet material is drawn into the inside of the fuser unit while the roller body is rotating by the inertia of the motor, and the sheet material can not be visually recognized from outside. In this case, the time required for the user to remove the sheet material is increased, or such a service call that the stop of an apparatus due to the JAM can not be released although the sheet material does not remain is frequently made. This causes such a disadvantage that the user can not use the image forming apparatus for many hours.

### BRIEF SUMMARY OF THE INVENTION

It is an object of the present invention to provide an image forming apparatus including a fuser unit in which even in the case where miss feed or sheet jam of sheet material occurs in the fuser unit, a user is facilitated to remove the sheet material without fail.

To achieve the above object, according to an aspect of the invention, there is provided an image forming apparatus comprising:

a fuser unit including a heating roller and a pressing roller;

a jam sensor to detect a jam of a sheet material transported in the fuser unit; and

a drive unit that drives the heating roller and the pressing roller in a forward direction at a time of an image formation operation, and once stops the rollers when the jam sensor detects the jam of the sheet material transported in the fuser unit, and then drives them in a reverse direction for a specified time.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing an example of an image forming apparatus to which an embodiment of the invention is applied;

FIG. 2 is a schematic view for explaining an example of a control system/drive system of the image forming apparatus explained using FIG. 1;

FIG. 3 is a schematic view for explaining a fuser unit incorporated in the image forming apparatus explained using FIGS. 1 and 2 and the periphery thereof;

FIG. 4 is a timing chart for explaining the timing of brake/motor off to a fuser unit motor for driving a roller body (fixing roller) of the fuser unit shown in FIG. 3;

FIG. 5 is a schematic view for explaining a state where a reversing unit is opened in the image forming apparatus explained using FIGS. 1 and 2;

FIG. 6 is a partially enlarged view for explaining the state where the reversing unit is opened in the image forming apparatus explained using FIGS. 1 and 2;

FIG. 7 is a partially enlarged view for explaining a state (state where the fuser unit is exposed) where a transfer block including a transfer unit (roller body) is further opened subsequently to the state where the reversing unit is opened as shown in FIG. 6; and

FIG. 8 is a photograph showing a state where the trailing end of a sheet is protruded from the fuser unit by reverse rotation of the fuser unit motor for a specified time in the state where the fuser unit is exposed as shown in FIG. 7.

### DETAILED DESCRIPTION OF THE INVENTION

Hereinafter, an embodiment of the invention will be described in detail with reference to the drawings.

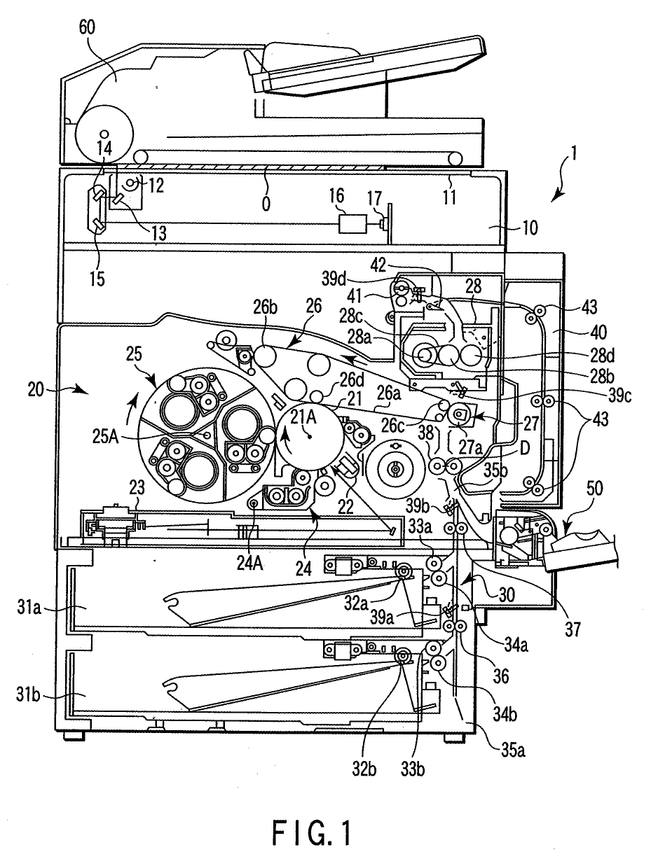

FIG. 1 is a schematic view showing an example of an image forming apparatus to which the embodiment of the invention is applied.

As shown in FIG. 1, an image forming apparatus 1 includes an image reader 10, an image forming unit 20, a sheet supply unit 30 and an automatic document feeder (ADF) 60. The image reader 10 captures image information of a copying (reading) object as the bright and dark (darkness) parts of the reflected light, and outputs a signal corresponding to the image information, that is, image data. The image forming unit 20 forms a copying image, that is, an output image based on the image data generated by the image reader 10. The sheet supply unit 30 feeds a sheet material to the image forming unit 20. In the case where the copying object is sheet-shaped, the automatic document feeder (ADF) 60 exchanges the copying object each time the image data is generated by the image reader 10 and the image is outputted by the image forming unit 20.

The image reader 10 includes a document table 11, an illumination unit 12, first to third mirrors 13, 14 and 15, a lens 16, a CCD sensor 17 and the like. The document table 11 holds the not-shown copying (reading) object. The illumination unit 12 illuminates the object set on the document table 11. The first to third mirrors 13, 14 and 15 sequentially guide the reflected light from the object illuminated by the illumination unit 12, that is, the image light to the CCD sensor 17. The lens 16 applies a specified image formation magnification to the image light guided (to itself) by the first to third mirrors 13, 14 and 15. The CCD sensor 17 receives the image light to which the specified image formation magnification has been applied by the lens 16, and outputs image data corresponding to the image light.

The image forming unit 20 includes a photoconductor 21, a main charging unit 22, an exposing unit 23, a black (first) developing unit 24, a color (second) developing unit 25, an intermediate transfer unit 26, a transfer block 27 including a transfer unit (roller body) 27a, a fuser unit 28 and the like.

The photoconductor 21 holds an electrostatic image generated by irradiation of light in a previously charged state. Since the photoconductor 21 has a cylindrical (drum) shape in the embodiment of the invention, it will be hereinafter referred to as a photoconductive drum.

The main charging unit 22 applies a specified surface potential to the photoconductor 21.

The exposing unit 23 irradiates the photoconductor 21 to which the specified surface potential has been applied by the main charging unit 22 with the light to which the intensity distribution corresponding to the image data has been applied.

The black (first) developing unit 24 selectively supplies a black (BK) toner to the latent image formed on the photoconductor 21.

The color (second) developing unit 25 supplies C (Cyan), M (Magenta) and Y (Yellow) toners in the specified order and selectively to the electrostatic latent image formed on the photoconductor 21.

The intermediate transfer unit 26 includes an intermediate transfer belt 26a, at least two roller bodies 26b and 26c which apply a specified tensile force to the intermediate transfer belt 26a and an intermediate transfer member, i.e., transfer charge supply roller 26d, which supply a specified electric field to the intermediate transfer belt 26a, which will be described below.

The transfer charge supply roller 26d is positioned inside the intermediate transfer belt 26a at a position where the intermediate transfer belt 26a and the photoconductive drum 21 are in contact with each other, and supplies the electric field, to transfer the toner image formed on the photoconductive drum 21 to the intermediate transfer belt 26a. The BK toner image, the C toner image, the M toner image and the Y toner image sequentially formed on the photoconductive drum 21 are sequentially stacked on the intermediate transfer belt 26a by the electric field applied by the transfer charge supply roller 26d.

The transfer unit (roller body) 27a of the transfer block 27 transfers the color toner image superimposed on the intermediate transfer belt 26a to a sheet material supplied at a specified timing. Various sheet materials typified by a sheet paper having a specified thickness, a transparent resin sheet (OHP sheet), an adhesive sheet in which an adhesive is applied to one surface thereof, and the like can be used as the sheet material.

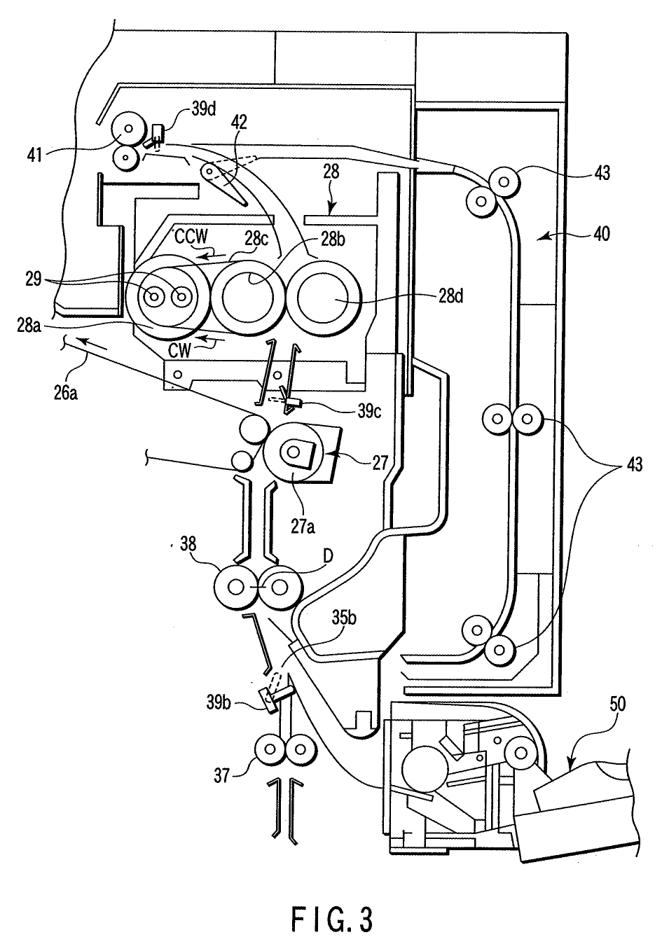

The fuser unit 28 fixes (fuses) the color toner image, which has been transferred on the sheet material, to the sheet material. Although described later by use of FIG. 3, the fuser unit 28 includes a heating roller provided with a heat source such as, for example, a halogen lamp heater or an induction heating unit, and a pressing roller that has an axial line parallel to the axial line of the heating roller and can apply a specified pressure to the heating roller. Incidentally, the roller called the pressing roller may also be provided with a heat source. In the example shown in FIG. 3, the heating roller includes a first roller 28a having a heater member 29 inside of the first roller 28a, a second roller 28b that is positioned in the vicinity of the first roller 28a and applies pressure to the sheet material, and a belt member 28c provided on the outer peripheries of the first and the second rollers 28a and 28b. A pressing (third) roller 28d applies pressure to the belt member 28c and the second roller 28b as a rotation shaft thereof.

The sheet material holding the toner image is transported between the belt member 28c and the third (pressing) roller 28d. By this, the toner fused by heat transmitted through the belt member 28c from the heater 29 is fixed to the sheet material by the pressure between the pressing (third) roller 28d and the second roller 28b.

The sheet supply unit 30 includes a sheet holding unit 35a that includes first and second slots 31a and 31b to which cassettes containing sheet materials of arbitrary sizes are mounted, first and second pickup rollers 32a and 32b for sending sheets contained in the cassettes from the cassettes mounted to each of the slots 31a and 31b to a transport path described later, first and second sheet feed rollers 33a and 33b for separating the sheets sent by the first and second pickup rollers 32a and 32b one by one by a difference between an abrasion force between the sheets and an abrasion force between the sheet and the roller, and separation rollers 34a and 34b put in contact with the respective sheet feed rollers and the like, and a sheet transport unit 35b that feeds the sheet sent from an arbitrary cassette to the image forming unit 20.

The sheet transport unit 35b includes a first intermediate transport roller 36 for transporting the sheet contained in the cassette 31b (in this example) set in the slot positioned on the side apart from the image forming unit 20 toward the image forming unit 20, a second intermediate transport roller 37 positioned between the first intermediate transport roller 36 and the image forming unit 20 and for sending the sheet toward the image forming unit 20, and an aligning roller 38 that temporarily stops the sheet at the upstream side of the transfer unit 27 and aligns the position of the color toner image superimposed on the intermediate transfer belt 26a with the position of the sheet. Besides, plural sensors 39a, 39b, . . . each detects the position of the sheet transported in the sheet transport unit 35b and for detecting the miss feed or sheet jam of the sheet (JAM) by comparison with the sheet transport time specified based on the length of the sheet are provided at specified positions of the sheet transport unit 35b. Incidentally, as an example, the first sensor 39a is positioned between the first intermediate transport roller 36 and the second intermediate transport roller 37, the second sensor 39b is positioned between the second intermediate transport roller 37 and the aligning roller 38, the third sensor 39c is positioned between the aligning roller 38 and the fuser unit 28, and the fourth sensor 39d is positioned between the fuser unit 28 and an ejecting/reversing roller 41 described later.

Downstream of the fuser unit 28, a reversing unit 40 is provided which can eject the sheet material to which the color toner image has been fixed by the fuser unit 28 to a copy reception unit as a space between the image reader 10 and the image forming unit 20, and if necessary, reverses the front and back of the sheet material (sheet) to one side of which the color toner image has already been fixed. The reversing unit 40 includes the ejecting/reversing roller 41 that outputs the sheet (sheet material) for which subsequent image formation is not performed (image formation and fixation are completed) to the copy reception unit and guides the sheet instructed to reverse the front and back (double-sided copying) to the reversing unit 40, a switching unit 42 to guide the sheet sent to the reversing unit 40 by the ejecting/reversing roller 41, and transport rollers 43, . . . , 43 to transport the sheet supplied to the reversing unit 40 to the aligning roller 38 and the like.

Incidentally, a manual feed unit 50 usable for feeding of a sheet having a certain thickness or more and an OHP sheet and the like, and a connection unit capable of guiding the sheet or the OHP sheet set on the manual feed unit 50 to the aligning roller 38, the detailed description of which will be omitted, are also provided in the vicinity of the reversing unit 40 in the sheet transport unit 35b, in this example, at a specified position located upstream of the aligning roller 38.

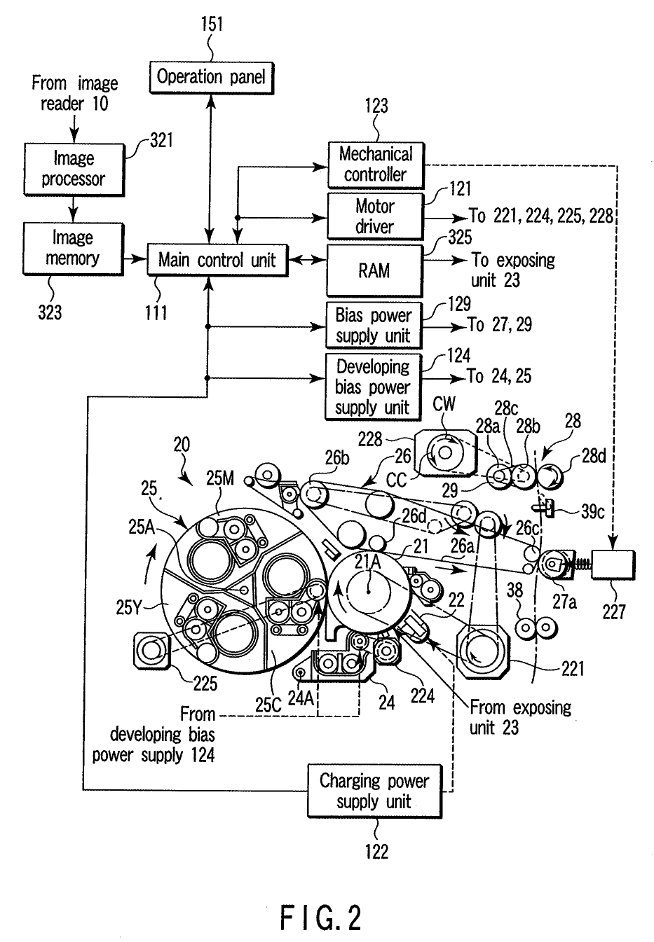

In the image forming apparatus 1 shown in FIG. 1, when a copying object (hereinafter referred to as an original document) is set on the document table 11 by the ADF 60 or directly, and start of copying is instructed from the operation panel 151 (see FIG. 2), illumination light is irradiated from the illumination unit 12 at a specified timing, and the original document O is illuminated. By this, the reflected light in which image information of the original document is included as the variations of light and shade is extracted. Hereinafter, this reflected light is referred to as an image light.

The image light is guided to the lens 16 through the first to third mirrors 13 to 15, a specified image formation magnification is set by the lens 16, and an image is formed on the CCD sensor 17.

The image light imaged on the CCD sensor 17 is photoelectrically converted by the CCD sensor, is converted into image data by an image processing unit 312 (see FIG. 2), and is stored in an image memory 323 (see FIG. 2).

A specified potential is applied to the surface of the photoconductive drum 21 by the charging unit 22 at a specified timing based on the illumination start of the original document by the illumination unit 12.

The image light the intensity of which is changed based on the image data is irradiated from the exposing unit 23, so that the surface potential of the photoconductive drum 21 to which the specified surface potential has been applied by the charging unit 22 is selectively changed. The potential difference on the photoconductive drum 21 is held as an electrostatic latent image on the photoconductive drum 21 for a specified period of time.

In the case where the electrostatic latent image held on the photoconductive drum 21 is the latent image corresponding to a black (BK) image, a black toner is supplied from the BK developing unit 24 so that it is developed and is visualized.

In the case where the electrostatic latent image held on the photoconductive drum 21 is the latent image corresponding to the image of an arbitrary color component other than black, the toner of the specified color is supplied by a developing unit holding the toner of the corresponding color in the color developing unit 25, and the latent image is visualized. The color developing unit 25 includes three monochromatic developing units 25C (Cyan), 25M (Magenta) and 25Y (Yellow) independently containing toners, and capable visualizing three color components separated based on the well-known subtractive process are formed to be rotatable around a rotation shaft 25A, and is called a revolver type.

The (monochromatic) toner image formed on the photoconductive drum 21 is transported to the intermediate transfer position where it comes in contact with the intermediate transfer belt 26a by rotation of the photoconductive drum 21, and is transferred to the intermediate transfer belt 26a by a specified transfer bias voltage supplied by the transfer charge supply roller 26d from the inside of the intermediate transfer belt 26a. In the case where the required image output (hard copy) is color, a C toner image, an M toner image and a Y toner image formed by each of the monochromatic developing unit 25C, 25M and 25Y in the color developing unit 25 are sequentially transferred onto the BK toner image formed by the black developing unit 24.

When the four-color toner images are superimposed and transferred on the intermediate transfer belt 26a, the sheet material (sheet or OHP sheet) guided to the aligning roller 38 is transported at a specified timing to the transfer position where the intermediate transfer belt 26a comes in contact with the transfer unit (roller body) 27a of the transfer block 27, and the output transfer bias voltage is supplied from the transfer unit 27a, so that all the toner images, that is, the color toner image is transferred to the sheet material.

The transfer unit (roller body) 27a of the transfer block 27 can be brought into contact/non-contact with the intermediate transfer belt 26a by a transferring distance keeping mechanism 227 (see FIG. 2), and at the time of non-transfer, the transfer unit is positioned at a retracted position where it is spaced from the intermediate transfer belt 26a by a specified distance so that the toner image stacked on the intermediate transfer belt 26a is not attracted with electrostatic force.

The toner images (BK+C+M+Y)as the full colored toner image transferred on the sheet material such as the sheet paper or OHP sheet are guided to the fuser unit 28 by the transport of the sheet material.

The toner images (color toner images) guided to the fuser unit 28, together with the sheet material, are heated by heat from the fuser unit 28 and are fused, and are fixed (fused) to the sheet material by the application of the specified pressure in the fuser unit 28.

The sheet (sheet material) is taken out one by one from the cassette contained in the first or second slot 31a or 31b or the manual feed unit 50 and is previously transported to the aligning roller 38.

The sheet transported to the aligning roller 38 is collided against the aligning roller 38 the rotation of which is stopped, so that a non-parallel component to the transport direction, that is, an inclination which can occur when the sheet is sent from the sheet holding unit 35a or when it is transported on the sheet transport path 35b is removed and the sheet is once stopped.

FIG. 2 shows an example of a control system of the color image forming apparatus explained using FIG. 1.

The original document is set on the document table 11, and start of copying is instructed from the operation panel 151, so that image data corresponding to the document image is obtained in the image reader 10.

The image data is processed in an image processing unit 321 in accordance with a previously determined image processing routine, and is stored in the image memory 323.

In the image formation unit 20 and the sheet supply unit 30, a specified number of drive pulses from a motor driver 121 by the control of a main control unit 111 are supplied at a specified timing corresponding to the start of reading of the document image by the image reader 10. As a result, a motor 221 for rotating a rotation center 21a of the photoconductive drum 21 and a drive shaft (roller) 26b of the intermediate transfer belt 26a in a specified direction is rotated at a specified rotation speed.

The specified number of pulses of motor drive pulse is inputted from the main control unit 111 to the motor driver 121, so that the motor 221 is rotated at the specified rotation speed. The rotation of the motor 221 is transmitted to the rotation center 21a of the photoconductive drum 21 and the drive shaft 26b of the intermediate transfer belt 26a by a not-shown transmission mechanism. By this, an arbitrary position of the circumference of the photoconductive drum 21 and an arbitrary position of the outer periphery of the intermediate transfer belt 26a are moved at the same speed.

Incidentally, the motor driver 121 is connected with a black developing rotor 224 to rotate a developing roller, which is not described in detail, of the black developing unit 24, a color developing motor 225 to rotate developing rollers, which are not described in detail, of the arbitrary monochromatic developing units 25C, 25M and 25Y of the color developing unit 25, and a fuser unit motor 228 to rotate an arbitrary roller (the second roller 28b in this example) of the fuser unit 28. The rotation and stop of each of the motors is controlled at a specified timing in a series of image forming operations subsequent to the rotation (driving of the motor 221) of the photoconductive drum 21 by the main control unit 111. Incidentally, although described below by use of FIG. 3, in the case where JAM (miss feed or sheet jam of sheet material) occurs in the fuser unit 28, the rotation due to the inertia is suppressed by a brake signal, so that the fuser unit motor 228 is stopped in a relatively short time. Besides, the motor is reversely rotated as needed.

A specified voltage and current are supplied to the charging unit 22 from a charging power supply unit 122 at a specified timing corresponding to the rotation start of the motor 221, and a specified surface potential is applied to the photoconductive drum 21 from the charging unit 22.

A developing bias voltage having a specified magnitude and polarity is applied from a developing bias power supply 124 to the developing roller of the black developing unit 24 at a specified timing corresponding to the charging start of the charging unit 22 to the photoconductive drum 21. At the same time or a specified timing, the black developing motor 224 is rotated, and the developing roller of the black developing unit 24 is rotated. Although not described in detail, the black developing unit 24 is positioned by a black developing position control mechanism to a black developing position where the surface of the photoconductive drum 21 and the surface of the developing roller are spaced by a specified distance, while for example, a rotation center 24a is made a rotation shaft.

Hereinafter, black image data stored in the image memory 323 is converted into exposure (serial) data for formation of an electrostatic latent image on the photoconductive drum 21 and is supplied to the exposing unit 23 at a specified timing (exposure timing) defined on the basis of, for example, a not-shown marker or the like provided at an arbitrary position of the belt surface or the back surface (inside) of the intermediate transfer belt 26a. As the conversion from the image data into the serial data, a well-known method is used, for example, expansion to a page memory (RAM) 325 in which the storage capacity equivalent to one page of image output is ensured, or transmission of each line of expanded parallel data to the exposing unit 23.

An electrostatic image (electrostatic latent image) of a black image is formed on the photoconductive drum 21 according to the black (BK) image light irradiated to the photoconductive drum 21 from the exposure device 23. The black electrostatic latent image is developed by the black developing unit 24. By this, the black (BK) toner image is formed on the photoconductive drum 21.

After a specified time has elapsed (end of black image exposure) since the time point when the black image data temporarily held in the RAM 325 was transferred to the exposure device 23, the black developing unit 24 is retracted from the black developing position to a specified retracted position according to the instruction (control command) from the main control unit 111. The supply of the developing bias voltage by the developing bias power supply 124 and the rotation of the developing roller by the black developing motor 224 are stopped at the specified timing.

The black toner image formed on the photoconductive drum 21 is guided by the rotation of the photoconductive drum 21 to the intermediate transfer position where it is brought into contact with the intermediate transfer belt 26a.

The black toner image guided to the intermediate transfer position is transferred (attracted) to the intermediate transfer belt 26a by the transfer electric field from the transfer charge supply roller 26d, is brought into contact with the intermediate transfer belt 26a inside the intermediate transfer belt 26a, to which a black intermediate transfer bias voltage Vtbk having a specified magnitude and polarity is applied by a bias power supply unit 129.

The black toner image transferred to the intermediate transfer belt 26a is sequentially moved in accordance with the movement of the belt surface of the intermediate transfer belt 26a, that is, the rotation of the drive shaft 26b. The pressing mechanism 227 to press/separate the roller body 27a to/from the intermediate transfer belt 26a is operated by a mechanical controller 123, so that the transfer unit (roller body) 27a of the transfer block 27 can be positioned at either a transfer position where the roller body is pressed to the outer peripheral surface of the intermediate transfer belt 26a or a non-transfer position where it is not in contact with the intermediate transfer belt 26a, and at this time point (while the black toner image is transferred), the roller body is retracted to the non-transfer position. Accordingly, the black toner image is again transported to the intermediate transfer position by the movement (rotation) of the belt surface of the intermediate transfer belt 26a.

With respect to the surface of the photoconductive drum 21 after the black toner image is transferred to the intermediate transfer belt 26a, toner which has not been transferred to the intermediate transfer belt 26a is removed by a drum cleaner not described in detail, and the surface is restored (reset) by a charge removal unit not described in detail to the potential distribution before the specified potential was applied from the charging unit 22.

Next, in accordance with the instruction of color image formation by the main control unit 111, the developing roller of an arbitrary monochromatic developing unit 25C, 25M and 25Y of the color developing unit 25 is positioned at a color developing position where it is opposite to a specified position of the outer periphery of the photoconductive drum 21 by the rotation of a not-shown color developing unit rotation motor or the transmission of drive force from the motor 221 by a not-shown transmission mechanism.

For example, in the case where an image to be stacked on the black toner image is a C (cyan) image, until the developing roller of the cyan (C) developing unit 25C of the color developing unit 25 becomes opposite to the photoconductive drum 21, the color developing unit 25 is rotated around the center shaft 25a in, for example, a CW (clock wise) direction (arrowed direction). Next, a specified voltage and current are supplied to the charging unit 22 from the charging power supply unit 122, and a specified surface potential is again applied to the photoconductive drum 21.

A developing bias voltage having a specified magnitude and polarity is applied from the developing bias power supply 124 to the developing roller of the cyan (C) developing unit 25C at a specified timing corresponding to the charge start of the charging device 22 to the photoconductive drum 21. At the same time or at a specified timing, the color developing motor 225 is rotated, and the developing roller of the cyan (C) developing unit 25C is rotated.

Next, the C (cyan) image data stored in the image memory 323 is converted into exposure (serial) data for formation of an electrostatic latent image on the photoconductive drum 21 by the RAM 325 based on an exposure timing defined based on the revolving of the intermediate transfer belt 26a, and is supplied to the exposure device 23.

By this, the electrostatic latent image of the cyan (C) image is formed on the photoconductive drum 21 correspondingly to the C image light irradiated to the photoconductive drum 21 from the exposing unit 23. The cyan (C) electrostatic latent image is developed by the C developing unit 25C. That is, the cyan toner image is formed on the photoconductive drum 21.

Since the black toner image has already been transferred on the intermediate transfer belt 26a, the cyan (C) image is exposed on the photoconductive drum 21 at a specified timing set so that the cyan image is superimposed on the black toner image on the intermediate transfer belt 26a to which the black toner image has already been transferred.

The cyan (C) toner image formed on the photoconductive drum 21 is transported by the rotation of the photoconductive drum 21 to the intermediate transfer position where it is in contact with the intermediate transfer belt 26a, and is superposed on the black toner image. At this time, a cyan intermediate transfer bias voltage Vtc having an absolute value larger than the black intermediate transfer bias voltage Vtbk is applied from the bias power supply unit 129 to the transfer charge supply roller 26d.

By this, the black toner image already transferred on the intermediate transfer belt 26a is not returned to the photoconductive drum 21, and the cyan (C) toner image is superimposed on the black toner image on the intermediate transfer belt 26a and is transferred.

The cyan toner image transferred on the intermediate transfer belt 26a, together with the black toner image, is sequentially moved in accordance with the movement of the belt surface of the intermediate transfer belt 26a. Since the transfer unit (roller body) 27a of the transfer block 27 is retracted to the non-transfer position, the cyan (C) toner image and the black toner image are again transported to the intermediate transfer position.

On the other hand, with respect to the surface of the photoconductive drum 21 after the cyan (C) toner image is transferred to the intermediate transfer belt 26a, toner which has not been transferred to the intermediate transfer belt 26a is removed, and the surface is restored to the potential distribution before the specified potential was applied from the charging unit 22.

Hereinafter, the developing roller of the magenta (M) developing unit 25M of the color developing unit 25 is rotated around the center shaft 25a in, for example, the arrow direction until the developing roller becomes opposite to the photoconductive drum 21, and a magenta (M) toner image is formed and is transferred to the intermediate transfer belt 26a through a process similar to the transfer of the cyan toner image.

Further, the developing roller of the yellow (Y) developing unit 25Y of the color developing unit 25 is rotated around the center shaft 25a in, for example, the arrow direction until the developing roller becomes opposite to the photoconductive drum 21, and a yellow (Y) toner image is formed and is transferred to the intermediate transfer belt 26a through a process similar to the transfer of the cyan (C) toner image described before.

In this way, the Y toner image is superimposed on the black toner image, the C toner image, and the M toner image which has already been transferred on the intermediate transfer belt 26a and is transferred.

Incidentally, the transfer voltage applied to the transfer charge supply roller 26d is appropriately set, so that each of or at least arbitrary two of the toner images of BK (black), C (cyan) and M (magenta) previously transferred on the intermediate transfer belt 26a are superimposed (transferred) on the intermediate transfer belt 26a without being returning to the photoconductive drum 21.

Hereinafter, the Y (yellow) toner image transferred on the intermediate transfer belt 26a, together with the black toner image, the C (cyan) toner image and the M (magenta) toner image, is transported to the intermediate transfer position in accordance with the movement of the belt surface of the intermediate transfer belt 26a.

On the other hand, with respect to the surface of the photoconductive drum 21 after the Y toner image is transferred to the intermediate transfer belt 26a, Y (yellow) toner which has not been transferred to the intermediate transfer belt 26a is removed, and the surface is restored to the potential distribution before the specified potential was applied from the charging unit 22.

In this way, the color toner image corresponding to the image data read by the image reader 10 and stored in the image memory 323 is formed on the intermediate transfer belt 26a.

Next, an operation in the case where JAM (miss feed or sheet jam of sheet material) occurs in the fuser unit 28 will be described.

As described in detail by use of FIG. 3, there are included the first roller 28a having the built-in heater 29, the second roller 28b positioned in the vicinity of the first roller 28a and for applying pressure to the sheet material, the belt member 28c provided on the outer peripheries of the first and the second rollers 28a and 28b, and the pressing (third) roller 28d for applying pressure to the belt member 28c and the second roller 28b as the rotation shaft thereof.

The sheet material holding the toner image is transported between the belt member 28c and the third (pressing) roller 28d. By this, the toner fused by heat transmitted through the belt member 28c from the heater 29 is fixed to the sheet material by the pressure between the pressing (third) roller 28d and the second roller 28b.

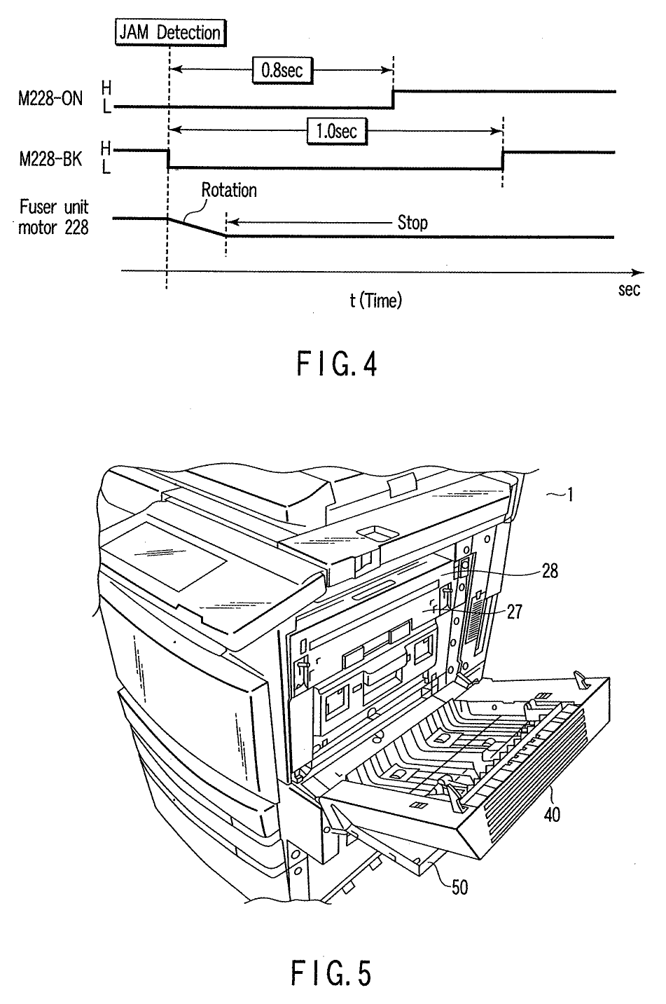

Incidentally, as shown in FIG. 2, although a description will be given below by use of FIG. 4, in the case where JAM (miss feed or sheet jam of the sheet material) occurs, the second roller 28b driven by the fuser unit motor 228 is braked at a specified timing (brake signal is supplied to the motor). By this, the rotation of the motor 228 due to the inertia is suppressed, and the rotation of each roller is stopped in a relatively short time.

In more detail, as shown in FIG. 4, control is executed as follows:

1. when JAM is detected during steady rotation, a motor brake signal M228-BK is made “L”, and a brake is applied to the motor 228;

2. after 0.8 sec since the brake was applied to the motor 228, a motor-on signal M228-ON is made “H”, and the motor is turned off; and

3. after 1.0 sec since the brake was applied to the motor 228, the motor brake signal M228-BK is made “H” and the brake is released.

However, there is a case where the brake is not applied (without) in accordance with the following condition.

(A) sheet weighing [weight (g) per 1 m²] with/without brake

| | | |
|---|---|---|
| standard paper: | 64-105 g | with |
| thick paper 1: | 106-163 g | with |
| thick paper 2: | 164-209 g | without |
| thick paper 3: | 210-256 g | without |

| | |
|---|---|
| special paper (with tab/postcard): | without |
| sheet material (OHP film): | without |

(B) Just after the occurrence of all JAM in which the fuser unit motor 228 is stopped and

(C) At the time of stop of the fuser unit motor of (A) and (B) with a brake signal is applied to stop the motor.

That is, in the case where the thickness of the sheet exceeds 105 g/m², since the pressure between the second roller 28b (belt 28c) and the third roller 28d rises and becomes a load, the influence of the inertia at the stop of the motor 228 becomes small (with respect to a sheet having a certain thickness or more, it is not necessary to consider the influence of the inertia at the time of stop of the motor 228).

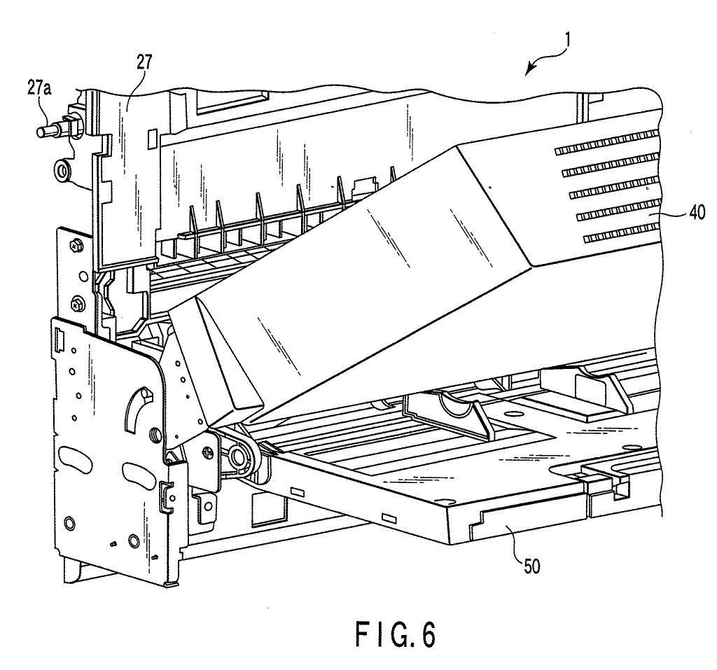

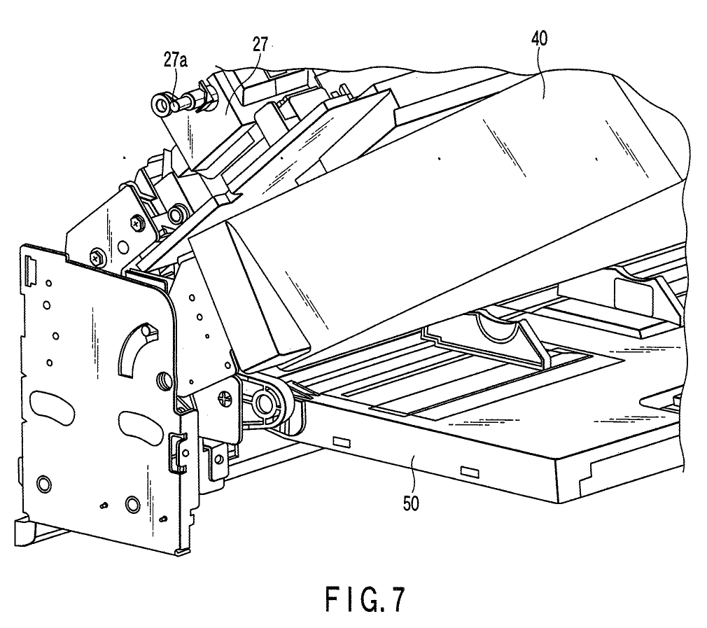

On the other hand, with respect to a sheet shorter than a certain length, there is a case where even if the brake is applied to the motor 228, the trailing end of the sheet is concealed in the fuser unit 28. That is, when JAM occurs in the fuser unit 28, as shown in FIGS. 5 and 6, the reversing unit 40 is opened to the manual feed unit 50 side, and after the transfer block 27 containing the transfer unit (transfer roller) 27a is exposed, as shown in FIG. 7, the transfer block 27 is opened, and the region, before the fuser unit 28, of the sheet transport unit 35b is exposed, and the JAM sheet can be removed. However, with respect to a sheet shorter than a certain length, there is a case where the trailing end of the sheet can not be seen from the fuser unit 28.

Accordingly, in the case where the sheet shorter than the certain length is jammed in the fuser unit 28, it is desirable that the fuser unit motor 228 is reversed for a specified time (specified number of rotations) based on the condition described below, and the trailing end of the sheet is moved in the sheet transport unit 35b so that it can be seen. Incidentally, since plural speeds (three kinds in this example) at which the sheet is transported are set in accordance with the mode of image formation, the time during which the fuser unit motor 228 is reversed is set for each transport speed of the sheet at the time of image formation.

For example, as shown below in TABLES 1, 1A to 1C, 2 and 3, it is desirable that the fuser unit motor 228 is reversed for a specified time (specified number of rotations), and the trailing end of the sheet is moved in the sheet transport unit 35b so that it can be seen.

TABLE 1
[U] Sheet nipped by fixing nip is returned for each size

1. Motor reverse rotation after 1.2 sec since JAM detection
2. Reverse rotation speed is 75 mm/sec (motor 758 rpm)
3. Rotation times denote the TABLES 1A, 1B and 1C later

TABLE 1A
Normal operation is 75 mm/sec [thick paper 1] Motor
reverse rotation is performed so that the total of “size
(mm) in sheet feed direction” of JAM sheet and “reverse
rotation amount (mm)” becomes 195 mm.

| | | | sheet + | |
|---|---|---|---|---|
| | reverse | reverse | reverse | |
| | rotation | rotation | rotation | Common |
| Size | time | amount | amount | name |
| 148-149 mm | 0.63 | 47.25 | 195.25 | postcard |
| 150-159 mm | 0.6 | 45 | 195 | |
| 160-169 mm | 0.47 | 35.25 | 195.25 | |
| 170-179 mm | 0.33 | 24.75 | 195.75 | |
| 180-189 mm | 0.2 | 15 | 195 | B5 |
| 190-199 mm | 0 | 0 | — | |
| 200-209 mm | 0 | 0 | — | |
| 210-219 mm | 0 | 0 | — | A4, LT |
| 220-229 mm | 0 | 0 | — | |
| 230-239 mm | 0 | 0 | — | |
| 240 mm or more | 0 | 0 | — | |

TABLE 1B
Normal operation is 150 mm/sec [color time] Motor
reverse rotation is performed so that the total of “size
(mm) in sheet feed direction” of JAM sheet and “reverse
rotation amount (mm)” becomes 200 mm.

| | | | sheet + | |
|---|---|---|---|---|
| | reverse | reverse | reverse | |
| | rotation | rotation | rotation | common |
| size | time | amount | amount | name |
| 148-149 mm | 0.69 | 51.75 | 199.75 | postcard |
| 150-159 mm | 0.67 | 50.25 | 200.25 | |
| 160-169 mm | 0.53 | 39.75 | 199.75 | |
| 170-179 mm | 0.4 | 30 | 200 | |
| 180-189 mm | 0.27 | 20.25 | 200.25 | B5 |
| 190-199 mm | 0.13 | 9.75 | 199.75 | |
| 200-209 mm | 0 | 0 | — | |
| 210-219 mm | 0 | 0 | — | A4, LT |
| 220-229 mm | 0 | 0 | — | |
| 230-239 mm | 0 | 0 | — | |
| 240 mm or more | 0 | 0 | — | |

TABLE 1C
Normal operation is 200 mm/sec [monochromatic image forming] Motor
reverse rotation is performed so that the total of “size
(mm) in sheet feed direction” of JAM sheet and “reverse
rotation amount (mm)” becomes 205 mm.

| | | | sheet + | |
|---|---|---|---|---|
| | reverse | reverse | reverse | |
| | rotation | rotation | Rotation | common |
| size | time | amount | amount | name |
| 148-149 mm | 0.76 | 57 | 205 | postcard |
| 150-159 mm | 0.73 | 54.75 | 204.75 | |
| 160-169 mm | 0.6 | 45 | 205 | |
| 170-179 mm | 0.47 | 35.25 | 205.25 | |
| 180-189 mm | 0.33 | 24.75 | 204.75 | B5 |
| 190-199 mm | 0.2 | 15 | 205 | |
| 200-209 mm | 0 | 0 | — | |
| 210-219 mm | 0 | 0 | — | A4, LT |
| 220-229 mm | 0 | 0 | — | |
| 230-239 mm | 0 | 0 | — | |
| 240 mm or more | 0 | 0 | — | |

TABLE 2
[V] Sheet nipped by fixing nip is returned for each size

1. Motor reverse rotation after 1.2 sec since JAM detection
2. Reverse rotation speed is 75 mm/sec (motor 758 rpm)
3. Rotation times denote the [A], [B] and [C] later
[A] Normal operation is 75 mm/sec [thick paper 1]
Jam sheet of any size is reversely rotated for 2.2 sec [165 mm]
[B] Normal operation is 150 mm/sec [color time]
Jam sheet of any size is reversely rotated for 2.4 sec [180 mm]
[C] Normal operation is 200 mm/sec [monochrome time]
Jam sheet of any size is reversely rotated for 2.6 sec [195 mm]

TABLE 3
[W] Not reached sheet ejection sensor (includes
a JAM occurrence not within the fuser unit, e.g., the
JAM occurrence within the sheet transport path 35b), sheet
nipped by fixing nip is returned for each size

1-1. Motor reverse rotation after 1.2 sec since detection of any JAM
occurrence in which fuser unit motor is stopped, except [U]
(TABLE 1) and [V] (TABLE 2)
1-2. Motor reverse rotation when there is no remaining sheet in paper
ejection sensor unit
2. Reverse rotation speed is 75 mm/sec (motor 758 rpm)
3. Rotation times denote the [I], [II] and [III] later
[I] Normal operation is 75 mm/sec [thick paper 1]
Jam sheet of any size is reversely rotated for 0.8 sec [60 mm]
[II] Normal operation is 150 mm/sec [color time]
Jam sheet of any size is reversely rotated for 0.94 sec [70.5 mm]
[III] Normal operation is 200 mm/sec [monochrome time]
Jam sheet of any size is reversely rotated for 1.0 sec [75 mm]

Incidentally, while only the fuser unit motor 228 is reversed for the time (specified number of rotations) explained using TABLES 1, 1A to 1C, 2 and 3, in the case where a sheet is detected by the sensor 39c positioned between the aligning roller 38 and the fuser unit 28, the rotation of the fuser unit motor 228 may be stopped at the time point.

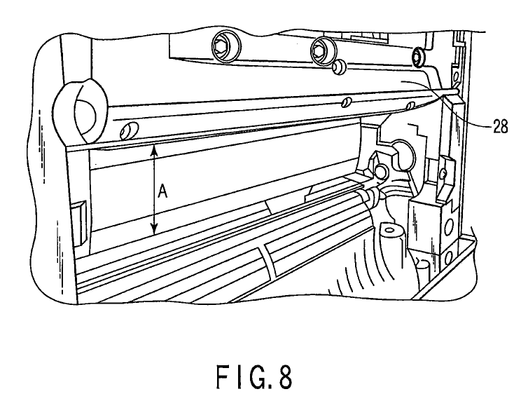

Besides, since the sensor 39c for detecting the position of the sheet in the sheet transport unit 35b is provided at the front stage (upstream side in the direction in which the sheet is transported) of the fuser unit 28, in order to prevent the sensor 39c from being damaged by the returned sheet, the maximum protrusion amount (denoted by “A” in FIG. 8) in the case where the trailing end of the sheet is exposed by the reverse rotation of the fuser unit motor 228 may be made 50 mm at the maximum.

That is, from TABLE 4 (reverse rotation control test) shown below, it is confirmed that only with respect to the postcard (thick paper of the size equivalent to A6) and B5, when transporting is made in the reverse direction by about 50 mm (the fuser unit motor 228 is reversely rotated), it is possible to prevent the sheet jammed in the fuser unit from being concealed in the fuser unit, and therefore, in order to prevent the damage of the sensor 39c, it is sufficient if the amount by which the trailing end of the sheet is protruded from the fuser unit is 50 mm.

TABLE 4
Length of sheet trailing end distance [A (see FIG. 8)] is measured
according to whether reverse rotation control is performed or not

| <without(0)/with(3)> | [postcard] | [B5] | [A4] |
|---|---|---|---|
| 0 (no reverse rotation) | 0 | 22 | 53 |
| 0 (no reverse rotation) | — | 25 | 54 |
| 0 (no reverse rotation) | — | 27 | — |
| 3 (with reverse rotation) | 48 | 50 | — |
| 3 (with reverse rotation) | 50 | 52 | — |
| 3 (with reverse rotation) | — | 49 | — |
| 3 (with reverse rotation) | — | 62 | — |
| 3 (with reverse rotation) | — | 48 | — |

As described above, according to the embodiment of the invention, when JAM occurs in the fuser unit, the fuser unit motor is forcibly stopped to prevent the sheet from further advancing by the inertia of the motor, and the fuser unit motor is reversely rotated for a certain time or a certain distance according to the sheet size, so that it is possible to prevent the sheet jammed in the fuser unit from being concealed in the fuser unit. By this, it is possible to prevent the occurrence of the disadvantage that the JAM sheet remains in the fuser unit or the sheet is concealed in the fuser unit and it is impossible to find the position where the sheet is jammed.

Accordingly, the image forming apparatus can be provided in which even if JAM that the sheet material remains in the fuser unit occurs, the sheet material can be removed without fail.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a fuser unit including a heating roller and a pressing roller;
a jam sensor to detect a jam of a sheet material transported in the fuser unit; and
a drive unit that drives the heating roller and the pressing roller in a forward direction at a time of an image formation operation, and once stops the rollers when the jam sensor detects the jam of the sheet material transported in the fuser unit, and then drives them in a reverse direction for a specified time.

2. An image forming apparatus comprising:
a fuser unit including a heating roller and a pressing roller;
a jam sensor to detect a jam of a sheet material transported in the fuser unit; and
a drive unit that drives the heating roller and the pressing roller in a forward direction at a time of an image formation operation, and once stops the rollers when the jam sensor detects the jam of the sheet material transported in the fuser unit, and then drives them in a reverse direction for a specified time according to a set sheet size.

3. An image forming apparatus comprising:
a fuser unit including a heating roller and a pressing roller;
a jam sensor to detect a jam of a sheet material transported in the fuser unit;
a drive unit that drives the heating roller and the pressing roller in a forward direction at a time of an image formation operation, and once stops the rollers when the jam sensor detects the jam of the sheet material transported in the fuser unit, and then drives them in a reverse direction for a specified time; and
a sheet material stop sensor to detect a specified position of the sheet material and to stop driving of the drive unit in the reverse direction.

4. An image forming apparatus comprising:
an image carrier to carry, as a latent image, a potential distribution corresponding to image information;
a developing unit to selectively supply a developer to the latent image carried by the image carrier to form a developer image;
a belt body which has an image holding surface formed like a belt and to which the developer image formed by the developing unit is transferred;
a transfer unit that applies a specified pressure and electric field to the belt body in a state where a sheet material intervenes between the transfer unit and the belt body and electrostatically attracts and transfers the developer image transferred on the belt body to the sheet material;
a fuser unit that includes a continuous pressing and heating surface to apply pressure and heat to the sheet material and the developer image transferred to the sheet material, applies the heat and the pressure to the developer image transferred to the sheet material by the transfer unit and the sheet material, and fixes the developer image to the sheet material; and
a drive unit that applies a drive force to move the pressing and heating surface in a first direction, and temporarily cuts off the drive force in a case where the sheet material does not pass through the fuser unit in a specified time, and then applies a drive force, which is opposite to the drive force and is for moving the pressing and heating surface in a second direction opposite to the first direction, to the pressing and hearing surface for a specified time.

5. The image forming apparatus according to claim 4, wherein the pressing and heating surface of the fuser unit includes an outer peripheral surface of a roller body rotatable around a center shaft in one of the first direction and the second direction.

6. The image forming apparatus according to claim 5, wherein the drive unit includes a motor unit to rotate the roller body around the center shaft.

7. The image forming apparatus according to claim 6, wherein the drive unit reversely rotates the roller body for a specified time or a specified number of rotations regulated based on a size of the sheet material.

8. The image forming apparatus according to claim 6, wherein the drive unit reversely drives the roller body for a specified time or a specified number of rotations in a case where a size of the sheet material is smaller than a specified size.

9. The image forming apparatus according to claim 6, wherein the drive unit reversely rotates the roller body for a specified time or a specified number of rotations to cause the sheet material to have a protrusion amount regulated based on a size of the sheet material.

10. The image forming apparatus according to claim 6, wherein the drive unit reversely rotates the roller body for a specified time or a specified number of rotations to cause the sheet material to have a protrusion amount regulated based on a size of the sheet material in a case where a size of the sheet material is smaller than a specified size.

11. The image forming apparatus according to claim 6, wherein the drive unit reversely rotates the roller body until an end of the sheet material is detected by a sensor provided at a specified position.

12. The image forming apparatus according to claim 6, wherein the drive unit reversely rotates the roller body for a specified time or a specified number of rotations regulated based on a thickness of the sheet material.

13. The image forming apparatus according to claim 6, wherein the drive unit reversely rotates the roller body for a specified time or a specified number of rotations in a case where a thickness of the sheet material is thinner than a specified thickness.

14. A method for forming an image comprising:
forming a developer image by selectively supplying a developer based on a potential distribution corresponding to image information;
electrostatically attracting and transferring the formed developer image to a sheet material;
fixing the developer image to the sheet material by applying heat and pressure to the developer image transferred to the sheet material and the sheet material; and
cutting off a drive force in a forward direction applied to the sheet material in a case where the sheet material is not ejected in a specified time, and then applying a drive force in a direction opposite to that of the drive force in the forward direction for a specified time.

15. The method according to claim 14, wherein the drive force in the opposite direction is applied for the specified time regulated based on a size of the sheet material.

16. The method according to claim 14, wherein the drive force in the opposite direction is applied for the specified time in a case where a size of the sheet material is smaller than a specified size.

17. The method according to claim 14, wherein the drive force in the opposite direction is applied until a protrusion amount regulated based on a size of the sheet material is given to the sheet material.

18. The method according to claim 14, wherein the drive force in the opposite direction is applied until a protrusion amount regulated based on a size of the sheet material is given to the sheet material in a case where the size of sheet material is smaller than a specified size.

19. The method according to claim 14, wherein the drive force in the opposite direction is continuously applied until an end of the sheet material is detected by a sensor provided at a specified position.
